(19) United States
(12) Patent Application Publication
(10) Pub. No.: US 2012/0050218 A1
(43) Pub. Date: Mar. 1, 2012

(54) PORTABLE ELECTRONIC DEVICE AND OPERATION METHOD USING THE SAME

(75) Inventors: CHIH-CHIEN CHU, Tu-Cheng (TW); CHAO-YUN YU, Tu-Cheng (TW); FA-HSIANG CHANG, Tu-Cheng (TW)

(73) Assignee: CHI MEI COMMUNICATION SYSTEMS, INC., Tu-Cheng (TW)

(21) Appl. No.: 13/152,286

(22) Filed: Jun. 3, 2011

(30) Foreign Application Priority Data
Aug. 26, 2010 (TW) 99128597

(51) Int. Cl. G06F 3/044

(52) U.S. Cl. 345/174

(57) ABSTRACT

A portable electronic device and an operation method using the portable electronic device include presetting function modes applicable to specific user interfaces of the portable electronic device, and presetting operations in each of the function modes and a command corresponding to each of the operations. Signals are detected from a first and a second proximity sensors of the portable electronic device, and a time length of each signal is calculated. A command corresponding to a current operation is executed if the current operation is determined to accord with one of the preset operations according to the detected signals and the time length.

### BACKGROUND

1. Technical Field

Embodiments of the present disclosure relate to operation methods of an electronic device, and more particularly to an operation method using a portable electronic device with one or more proximity sensors and the portable electronic device thereof.

2. Description of Related Art

Portable electronic devices are used for viewing e-books, websites and images on a display of the portable electronic device. A common control technique for viewing the e-books, websites and images on the display is to use a physical keypad of the electronic device or a virtual keypad displayed on a touch screen of the portable electronic device.

However, the touch screen of the portable electronic device is often not large enough such that it creates inconvenience for the user when viewing websites and the images through the touch screen. In addition, turning pages, viewing the websites and images using the physical keypad may also be difficult, as it is not simple and intuitive to the user. Thus, an operation method of the portable electronic device is desired.

### BRIEF DESCRIPTION OF THE DRAWINGS

FIG. 1 is a schematic diagram of one embodiment of a portable electronic device.

FIG. 2 is a block diagram of one embodiment of the portable electronic device of FIG. 1.

FIG. 3 is a schematic diagram of one embodiment of a command table including relationships of function modes, operations, and commands of the portable electronic device of FIG. 1.

FIG. 4 is a flowchart of one embodiment of an operation method using a portable electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

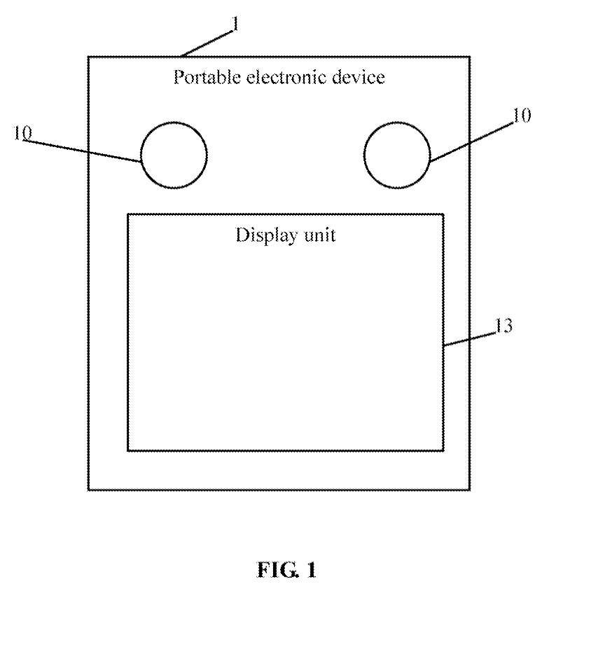

FIG. 1 is a schematic diagram of one embodiment of a portable electronic device 1. The portable electronic device 1 includes proximity sensors 10 and a display unit 13. The proximity sensors 10 comprise circuitry that can detect when a hand, finger, palm of the hand, or other body parts of a user are proximate to the portable electronic device 1. The proximity sensors 10 generate signals corresponding to the user operations. For example, when the user is proximate to the proximity sensors 10 with his/her fingers, the proximity sensors 10 can generate corresponding signals.

In one embodiment, two proximity sensors 10 are configured in the portable electronic device 1 to detect the user operations. The proximity sensors 10 can be configured in different positions of the portable electronic device 1. As shown in FIG. 1, a first proximity sensor is positioned on an upper-right side of the display unit 13. In addition, a second proximity sensor is positioned on an upper-left side of the display unit 13, although the disclosure is not limited thereto.

The display unit 13 is operable to display visible data of the portable electronic device 1. For example, the display unit 13 displays a user interface of the portable electronic device 1. The display unit 13 can be a display screen, a resistive touch screen, or a capacitive touch screen.

The portable electronic device 1 is generally controlled and coordinated by an operating system software, such as UNIX, LINUX, WINDOWS, MAC OS X, an embedded operating system, or any other compatible operating systems. In other embodiments, the portable electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

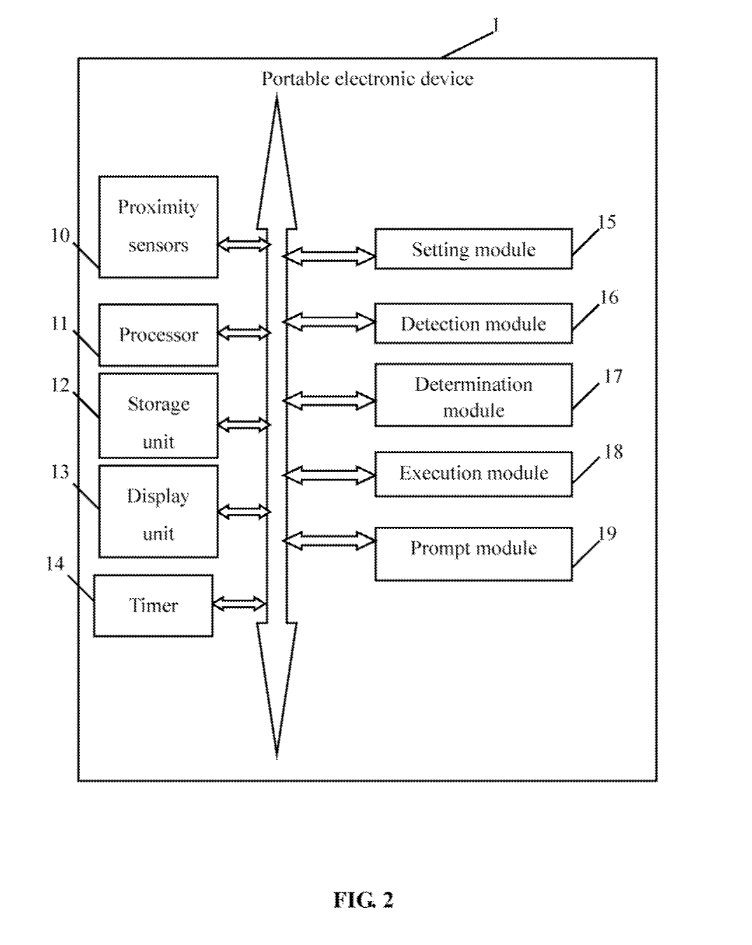

FIG. 2 is a block diagram of one embodiment of the portable electronic device 1. Depending on the embodiment, the portable electronic device 1 may be a mobile phone, a personal digital assistant (PDA), a handheld game console, a digital camera (DC), a handheld computer, or any other electronic device.

The portable electronic device 1 includes the proximity sensors 10, at least one processor 11, a storage unit 12, the display unit 13, a timer 14, and one or more programs including a setting module 15, a detection module 16, a determination module 17, an execution module 18, and a prompt module 19.

The modules 15-19 may comprise computerized code in the form of one or more programs that are stored in the storage unit 12 (or memory). The computerized code includes instructions that are executed by the at least one processor 11 to provide functions for modules 15-19. The at least one processor 11, as an example, may include a CPU, math coprocessor, shift register, for example.

The storage unit 12 is electronically connected to the proximity sensors 10, the at least one processor 11, the display unit 13, the timer 14 and the modules 15-19. The storage unit 12 is operable to store many kinds of data, such as the signals detected from the proximity sensors 10, images, e-books, customization function code of the portable electronic device 1, computerized codes of the user interface of the portable electronic device 1, programs of an operating system and other applications of the portable electronic device 1. The storage unit 12 may include a hard disk drive, flash memory, RAM, ROM, cache, or external storage mediums.

The setting module 15 is operable to preset function modes applicable to specific user interfaces of the portable electronic device 1, and preset operations on the proximity sensors 10 (e.g., the first and the second proximity sensors) in each of the function modes. The setting module further presets a command corresponding to each of the operations. In some embodiments, the specific user interfaces may include, but are not limited to Web page interface, text interface, image interface. In other words, a user may view or modify information (e.g., Web pages, images, messages) through the specific user interfaces. The function modes being applicable to the specific user interfaces may help the user to view or modify the information easily and efficiently. The commands corresponding to the operations are the program codes, executable instructions with functionally executed by the at least one processor 11, such as a last page command, a next page command, zoom in command or other functional commands operated in the function modes.

In some embodiments, the function modes may include, but are not limited to a turning page mode, a scrolling mode, and a zooming mode. In the turning page mode, a current page may be turned to a next page, or returned to a previous page according to user operations on the portable electronic device 1. The operations on the proximity sensors 10 in each of the function modes may include, but are not limited to a long-time proximity to the first proximity sensor, a short-time proximity to the first proximity sensor, a long-time proximity to the second proximity sensor, a short-time proximity to the second proximity sensor, a slide operation from the first proximity sensor to the second proximity sensor, and a slide operation from the second proximity sensor to the first proximity sensor. The slide operation from the first proximity sensor to the second proximity sensor may represent that the user is first proximate to the first proximity sensor for a short time, and then proximate to the second proximity sensor for a short time with the slide operation occurring within a determined time interval (e.g., 0.5 second) preset by the setting module 15. The above-mentioned operations may be grouped in any combinations.

The long-time proximity and the short time proximity to the proximity sensors 10 are determined by a time length of the signals detected from the proximity sensors 10. The setting module 15 may preset or modify a predetermined time to distinguish the long-time proximity or short-time proximity to the proximity sensors 10 to according to user requirements. For example, the predetermined time may be preset as 1 second. If the time length that the user is proximate to the first or the second proximity sensor is less than 1 second, the operation is determined to be the short-time proximity. If the time length that the user is proximate to the first or the second proximity sensor is over 1 second, the operation is determined to be the long-time proximity.

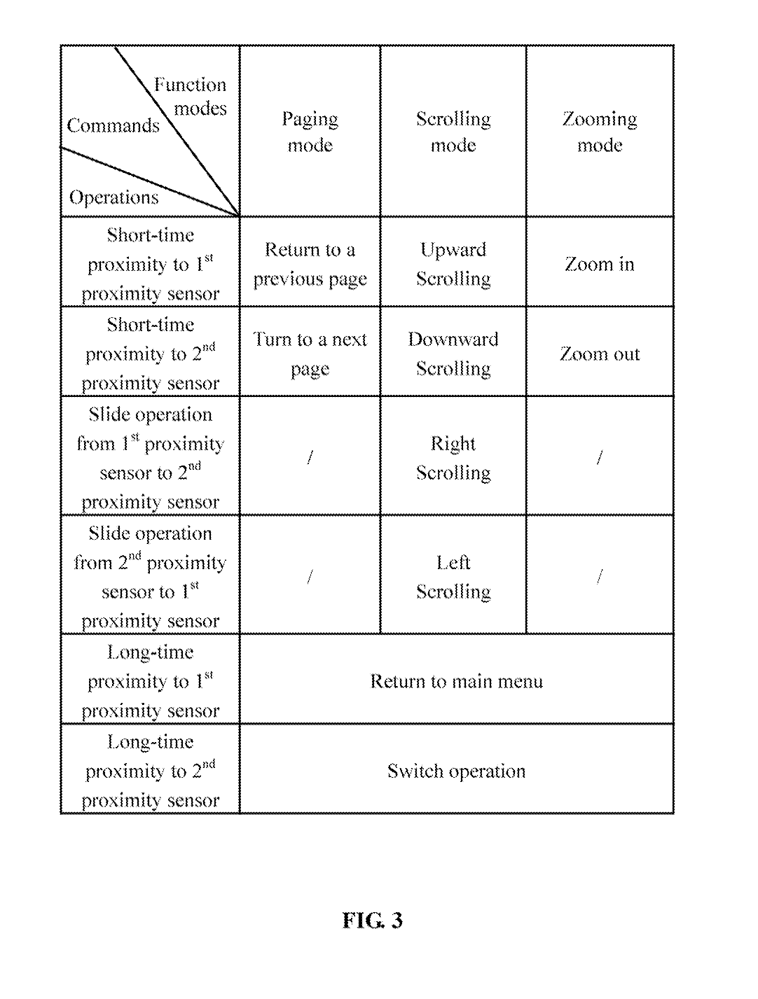

Referring to FIG. 3, a schematic diagram of a command table including relationships of the function modes, the operations, and the commands is shown. When the function modes (e.g., the turning page mode, the scrolling mode, and the zooming mode) are applicable to a user interface (e.g., the image interface) of the portable electronic device 1, the user interface of the portable electronic device 1 may be operated by determining a selected function mode according to user operation and detecting operations on the proximity sensors 10 in the selected function mode. In one embodiment, the user selects the scrolling mode to upward scroll an image on the user interface through the operation of short-time proximity to the first proximity sensor, for example, the user's finger(s) is short-time proximate to the first proximity sensor in the scrolling mode. The user also may scroll the image towards right through the slide operation from the first proximity sensor to the second proximity sensor.

The setting module 15 may further preset an invoke operation to invoke each of the function modes, and preset a switch operation for switching between the function modes in the user interface. For example, the invoke operation and the switch operation may be executed using a hotkey (e.g., a keystroke of the portable electronic device 1) or a preset operation on the proximity sensor(s) 10, such as the switch operation may be a long-time proximity to the second proximity sensor.

The detection module 16 determines the selected function mode by detecting user operations on a current user interface of the portable electronic device 1. The detection module 16 further detects signals received from the first and the second proximity sensors, and determines a time length of each of the detected signals using the timer 14. When the user operations on the proximity sensors 10 of portable electronic device 1, the proximity sensors 10 generate corresponding signals and send to the detection module 16. The timer 14 calculates the time length of the detected signals detected from the proximity sensors 10. In some embodiments, when the user is proximate to the first proximity sensor for 0.5 seconds, the timer 14 calculates the time length of the signal from the first proximity sensor as 0.5 seconds.

The determination module 17 determines if the selected function mode is applicable to the current user interface of the portable electronic device 1. If the selected function mode is applicable to the current user interface, the determination module 17 further determines if a current operation of the use on the portable electronic device 1 accords with one of the preset operations in the selected function mode according to the detected signals and the time length.

If the current operation accords with one of the preset operations in the selected function mode, the determination module 17 sends a command corresponding to the current operation to the execution module 18. The execution module 18 executes the command corresponding to the current operation received from the determination module 17.

If the current operation does not accord with any preset operations in the selected function mode, the prompt module 19 displays a correct operation prompt on the display unit 13. In another embodiment, the prompt module 19 also may output a voice prompt to prompt the correct operation, through a speaker of the portable electronic device 1.

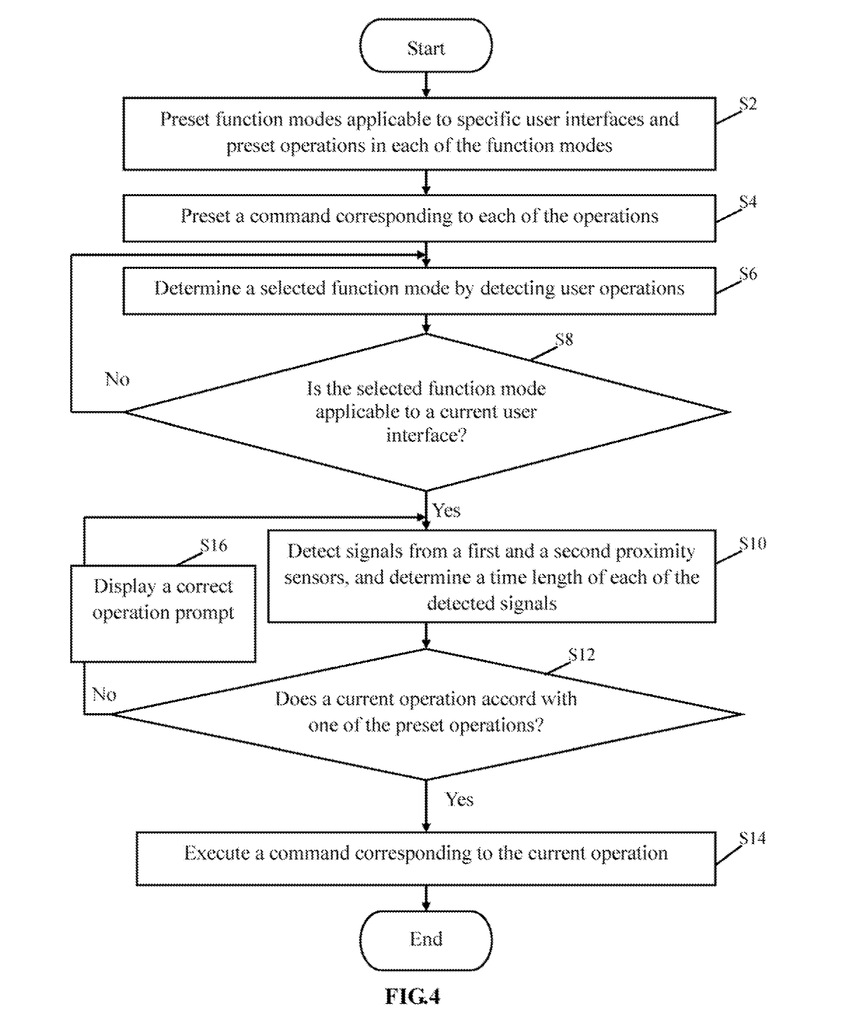

FIG. 4 is a flowchart of one embodiment of an operation method using the portable electronic device 1. Depending on the embodiment, additional blocks may be added, others deleted, and the ordering of the blocks may be changed.

In block S2, the setting module 15 preset function modes applicable to specific user interfaces of the portable electronic device 1, preset operations on the proximity sensors 10 (e.g., the first and the second proximity sensors) in each of the function modes, and saves the function modes and corresponding operations in the storage unit 12. As mentioned above, the function modes may include, but are not limited to a turning page mode, a scrolling mode, and a zooming mode.

In block S4, the setting module 15 presets a command corresponding to each of the operations, and saves the commands corresponding to the operations in the storage unit 12.

In block S6, the detection module 16 determines a selected function mode by detecting user operations on a current user interface.

In block S8, the determination module 17 determines if the selected function mode is applicable to the current user interface of the portable electronic device 1. If the selected function mode is not applicable to the current user interface, the process returns to block S6.

If the selected function mode is applicable to the current user interface, in block S10, the detection module 16 detects signals received from the first and the second proximity sensors, and determines a time length of each of the detected signals using the timer 14.

In block S12, the determination module 17 determines if a current operation of the user on the portable electronic device 1 accords with one of the preset operations in the selected function mode according to the detected signals and the time length.

If the current operation accords with one of the preset operations in the selected function mode, in block S14, the execution module 18 executes a command corresponding to the current operation in the selected function mode of the portable electronic device 1.

If the current operation does not accord with any preset operations in the selected function mode, in block S16, the prompt module 19 displays a correct operation prompt on the display unit 13, and the procedure returns to block S10. As mentioned above, the prompt module 19 also may output a voice prompt to prompt the correct operation, through a speaker of the portable electronic device 1.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A portable electronic device, comprising:
a storage unit;
a display unit;
at least one processor;
a timer;
a first proximity sensor;
a second proximity sensor;
one or more programs that are stored in the storage unit and are executed by the at least one processor, the one or more programs comprising:
a setting module operable to preset function modes applicable to specific user interfaces of the portable electronic device, preset operations in each of the function modes, and preset a command corresponding to each of the operations;
a detection module operable to detect signals received from the first and the second proximity sensors, and determine a time length of each of the detected signals using the timer;
a determination module operable to determine a selected function mode in response to receiving user selection on a current user interface of the portable electronic device, and determine if a current operation of the portable electronic device accords with one of the preset operations in the selected function mode according to the detected signals and the time length, under the condition that the selected function mode is applicable to the current user interface; and
an execution module operable to execute a command corresponding to the current operation if the current operation accords with one of the preset operations in the selected function mode.

2. The portable electronic device according to claim 1, wherein the setting module is further operable to preset a switch operation for switching between the function modes in a user interface of the portable electronic device.

3. The portable electronic device according to claim 1, the one or more programs further comprises a prompt module operable to display a correct operation prompt on the display unit if the current operation does not accord with the preset operations in the selected function mode.

4. The portable electronic device according to claim 1, wherein the first and the second proximity sensors are configured in different positions of the portable electronic device.

5. The portable electronic device according to claim 1, wherein the function modes comprise a turning page mode, a scrolling mode, and a zooming mode.

6. The portable electronic device according to claim 1, wherein the operations in each of the function modes comprise a long-time proximity to the first proximity sensor, a short-time proximity to the first proximity sensor, a long-time proximity to the second proximity sensor, a short-time proximity to the second proximity sensor, a slide operation from the first proximity sensor to the second proximity sensor, and a slide operation from the second proximity sensor to the first proximity sensor.

7. An operation method using a portable electronic device, the portable electronic device comprising a first and a second proximity sensors, the method comprising:
presetting function modes applicable to specific user interfaces of the portable electronic device, presetting operations in each of the function modes, and presetting a command corresponding to each of the operations;
detecting signals received from the first and the second proximity sensors, and determining a time length of each of the detected signals using a timer of the portable electronic device;
determining a selected function mode in response to receiving user selection on a current user interface of the portable electronic device;
determining if a current operation of the portable electronic device accords with one of the preset operations in the selected function mode according to the detected signals and the time length, under the condition that the selected function mode is applicable to the current user interface; and
executing a command corresponding to the current operation if the current operation accords with one of the preset operations in the selected function mode.

8. The method according to claim 7, further comprising:
presetting a switch operation for switching between the function modes in a user interface of the portable electronic device.

9. The method according to claim 7, further comprising:
display a correct operation prompt on a display unit of the portable electronic device if the current operation does not accord with the preset operations in the selected function mode.

10. The method according to claim 7, wherein the first and the second proximity sensors are configured in different positions of the portable electronic device.

11. The method according to claim 7, wherein the function modes comprise a turning page mode, a scrolling mode, and a zooming mode.

12. The method according to claim 7, wherein the operations in each of the function modes comprise a long-time proximity to the first proximity sensor, a short-time proximity to the first proximity sensor, a long-time proximity to the second proximity sensor, a short-time proximity to the second proximity sensor, a slide operation from the first proximity sensor to the second proximity sensor, and a slide operation from the second proximity sensor to the first proximity sensor.

13. A storage medium storing a set of instructions, the set of instructions capable of being executed by a processor to perform an operation method using a portable electronic device, the portable electronic device comprising a first and a second proximity sensors, the method comprising:
presetting function modes applicable to specific user interfaces of the portable electronic device, presetting operations in each of the function modes, and presetting a command corresponding to each of the operations;
detecting signals received from the first and the second proximity sensors, and determining a time length of each of the detected signals using a timer of the portable electronic device;
determining a selected function mode in response to receiving user selection on a current user interface of the portable electronic device;
determining if a current operation of the portable electronic device accords with one of the preset operations in the selected function mode according to the detected signals and the time length, under the condition that the selected function mode is applicable to the current user interface; and
executing a command corresponding to the current operation if the current operation accords with one of the preset operations in the selected function mode.

14. The storage medium as claimed in claim 13, wherein the method further comprises:
presetting a switch operation for switching between the function modes in a user interface of the portable electronic device.

15. The storage medium as claimed in claim 13, wherein the method further comprises:
display a correct operation prompt on a display unit of the portable electronic device if the current operation does not accord with the preset operations in the selected function mode.

16. The storage medium as claimed in claim 13, wherein the first and the second proximity sensors are configured in different positions of the portable electronic device.

17. The storage medium as claimed in claim 13, wherein the function modes comprise a turning page mode, a scrolling mode, and a zooming mode.

18. The storage medium as claimed in claim 13, wherein the operations in each of the function modes comprise a long-time proximity to the first proximity sensor, a short-time proximity to the first proximity sensor, a long-time proximity to the second proximity sensor, a short-time proximity to the second proximity sensor, a slide operation from the first proximity sensor to the second proximity sensor, and a slide operation from the second proximity sensor to the first proximity sensor.
